(19) United States
(12) Patent Application Publication
(10) Pub. No.: US 2013/0137127 A1
(43) Pub. Date: May 30, 2013

(54) DATING BLOODSTAINS AND BIOLOGICAL FLUIDS WITH FLUORESCENCE LIFETIME TECHNIQUES

(71) Applicant: Washington University, St. Louis, MO (US)

(72) Inventors: Mikhail Y. Berezin, St. Louis, MO (US); Samuel Achilefu, St. Louis, MO (US); Kevin Guo, Chesterfield, MO (US)

(73) Assignee: Washington University, St. Louis, MO (US)

(21) Appl. No.: 13/689,944

(22) Filed: Nov. 30, 2012

Related U.S. Application Data
(60) Provisional application No. 61/564,935, filed on Nov. 30, 2011.

(51) Int. Cl. G01N 21/64

(52) U.S. Cl. CPC G01N 21/6486
USPC 435/25; 436/86

(57) ABSTRACT

Methods of aging biological samples through the use of fluorescence lifetime are disclosed herein. These methods provide aging of samples such as bloodstains using endogenous fluorophores and conformational protein changes. Advantageously, the methods provide the average fluorescence lifetime across a region of interest in a biological sample, thereby minimizing problems with sampling and providing accurate results.

### CROSS REFERENCE TO RELATED APPLICATION

This application claims the benefit of U.S. Provisional Application No. 61/564,935, filed Nov. 30, 2011, which is hereby incorporated by reference in its entirety.

### BACKGROUND OF THE DISCLOSURE

The field of the disclosure relates generally to dating biological samples through the use of fluorescence. More particularly, the time-related degradation of tryptophan bearing proteins, such as albumin and γ-globulins, in blood is utilized to determine blood age.

Throughout history, bloodstain dating has played a significant role in areas such as criminal justice. Numerous violent crimes have remained unsolved for lack of evidence and the incapability to assign timing of bloodstains and other bodily fluids, thereby placing victims and potential defendants at the scene of the crime during the period at issue. Particularly, in the last two hundred years, criminal investigators explored a variety of approaches to establish a reliable quantitative method, from the evaluation of bloodstain color as shown in total organic carbon (TOC) analysis, microscopic analysis of red corpuscles and a water solubility scale in the middle of the 19th century, to electrochemistry, electron paramagnetic resonance, atomic force microscopy, polymer chain reaction, and optical spectroscopy in the 21st century. However, despite large efforts and obvious progress in related bloodstain techniques exemplified by computerized blood splatter analysis, ultra-sensitive mass-spectrometry based chemical composition of blood and DNA/RNA fingerprinting, bloodstain dating remains an unsolved challenge.

Accordingly, there is a need in the art for an accurate method of determining blood age. It would further be advantageous if this method could be used to determine the age of various biological samples.

### BRIEF DESCRIPTION OF THE DISCLOSURE

The present disclosure generally relates to a method for dating biological samples such as bloodstains based on the fluorescence lifetime of the sample. In some embodiments, the fluorescence lifetime value of a biological sample is determined through the detection of a conformational change of one more of a protein and an endogenous fluorophore. In another embodiment, the fluorescence lifetime value is determined through the presence of one or more of an organic quencher and an inorganic quencher.

Accordingly, in one embodiment, the present disclosure is directed to a method for determining the age of a biological sample. The method comprises measuring a fluorescence lifetime value of the biological sample.

In another embodiment, the present disclosure is directed to a method from determining the age of a biological sample. The method comprises measuring a fluorescence lifetime value of a standard biological sample at at least one pre-determined age; and comparing the fluorescence lifetime value of the biological sample to the fluorescence lifetime value of the standard biological sample.

In yet another embodiment, the present disclosure is directed to a method for determining the age of a blood sample. The method comprises measuring a fluorescence lifetime value of the blood sample.

### BRIEF DESCRIPTION OF THE DRAWINGS

FIG. 1A is a graph depicting the fluorescence lifetime of blood samples in PBS buffer as a function of aging time (up to 400 hours) as measured in Example 1. The fit (dashed lined) was calculated from the two-phase decay modeling. Insert in log scale shows all data up to 1600 hrs.

FIG. 1B is a graph depicting selected decays of blood samples in PBS buffer as measured in Example 1.

FIG. 2A is a graph depicting fluorescence decays of γ-globulin, albumin, and tryptophan in PBS buffer as measured in Example 2.

FIG. 2B is a graph depicting fluorescence lifetime of albumin (circles) and γ-globulin (squares) plated and treated in PBS buffer as measured in Example 2. Error <4% (Ex/em 295/350 nm).

FIG. 2C is a graph depicting fluorescence lifetime of albumin (circles) and γ-globulin (squares) plated and treated at different urea concentrations as measured in Example 2. Error <4% (Ex/em 295/350 nm).

FIG. 3 is a graph depicting fluorescence lifetime of albumin samples from different mammalian species as measured in Example 3.

FIG. 4A is an image showing fluorescence intensity of a 3-week old bloodstain as evaluated in Example 4.

FIG. 4B is an image of fluorescence lifetime of a 3-week old bloodstain as evaluated in Example 4.

### DETAILED DESCRIPTION OF THE DISCLOSURE

The present disclosure is directed to methods of aging biological samples through the use of fluorescence lifetime. In one embodiment, blood age is determined using the methods of the present disclosure. While described herein using blood as the biological sample, it should be recognized by one skilled in the art that various other biological samples, non-limiting examples which include biological fluids such as breast milk, bile, cerebrospinal fluid, gastric juice, mucus, saliva, semen, sweat, tears, urine, and the like and combinations thereof, can be aged using the methods of the present disclosure. Further, the biological samples can be dried biological samples and/or extracts of biological samples.

Fluorescence lifetime is an intrinsic property of endogenous fluorophores and refers to the average time the molecule(s) can exist in the excited state prior to emitting a photon. For most blood components, for example, the fluorescence lifetime varies from tens of picoseconds to several (up to 15) nanoseconds. Fluorescence lifetime is largely independent of the wavelength of excitation/emission, fluorophore concentration, and photobleaching. Since the de-excitation process is associated with an energetically unstable state, fluorescence lifetime is highly sensitive to a great variety of factors. For example, the fluorescence lifetime of tryptophan residues, one particular family of suitable endogenous fluorophores found in different proteins, particularly blood proteins, vary by more than a factor of 100 and are determined by solvent exposure and interactions with other elements of the protein matrix. It is now believed that this variance allows for monitoring of blood degradation with fluorescence lifetime.

Serum albumins and γ-globulins comprise more than 95% of the total protein mass in blood, and undergo conformational changes, and particularly, degradation, during blood aging. In one embodiment, the methods of the present disclosure provide for measuring the fluorescence lifetime of tryptophan, the major endogenous fluorophore in blood proteins, which is highly sensitive to the protein conformation of albumins and γ-globulins. The methods analyze the degradation of proteins, and thus the fluorescence lifetime of tryptophan, in blood to reflect the blood age.

In addition to tryptophan, other non-limiting suitable endogenous fluorophores for use in detecting the age of biological samples include fluorescent amino acids (in addition to tryptophan), porphyrins, lipofuscin, nicotinamide adenine dinucleotide (NADH) phosphate-oxidase, flavin adenine dinucleotide (FAD)-binding proteins, chlorophylls, and the like and combinations thereof.

Other suitable proteins of biological samples including endogenous fluorophores for use in the present methods include fibrinogen, hemoglobin, bilirubin, melanin, lignin, elastin, collagen, and the like, and combinations thereof.

In addition to the change in protein conformation, the release of a variety of organic and inorganic quenchers, such as primary, secondary, and tertiary amines or water and unbound iron-ions (Fe-ions), might also contribute to the change of fluorescence lifetime. It is believed that the release of the quenchers occurs due to the enzymatic activity of biological species or oxidative degradation of proteins. In a majority of the cases, the close proximity of the quencher to the fluorophore leads to a measurable change (i.e., decrease) of the fluorescence lifetime. In addition, it is further believed that the reactions of the fluorophore with chemicals, such as radicals, reducing compounds, and reactive oxygen and nitrogen species, form a different fluorescent compound with a different fluorescent lifetime, either lower or higher, depending on the product formed.

Generally, the methods of the present disclosure measure the fluorescence lifetime value of a biological sample, thereby determining the age of the sample, by centrifuging the sample and separating the supernatant for use in fluorescence measurements. In one embodiment, the sample is mixed with a buffer. Buffer is mixed with the sample to eliminate any effects due to pH and other environmental factors. Any buffer known in the art is suitable for use in the present methods. In one suitable embodiment, the buffer is phosphate-buffered saline (PBS).

Fluorescence lifetime measurements can be measured using any fluorescence lifetime instrument known in the art. In one particularly suitable embodiment, fluorescence lifetime measurements are measured using a time correlated single-photon-counting technique (TCSPC) in quartz cuvettes.

In one particular embodiment, the method of the present disclosure includes measuring the fluorescence lifetime value of a standard biological sample at a pre-determined age and then comparing the fluorescence lifetime value of a biological sample to the fluorescence lifetime value of the standard biological sample. The standard biological sample can be a biological fluid as described above for the biological sample. Suitable standard biological samples include, for example, human blood serum samples exposed to standard quenchers as known in the art.

In some embodiments, the measurements can be potentially performed in solid state, such as with a dried biological sample, using a handheld fluorescence lifetime instrument, which could be directly applied to the biological sample with no additional sample handling

The major advantage of the methods of the present disclosure is that the average fluorescence lifetime is evaluated across the region of interest in the biological sample. Such an approach will minimize the problems with sampling and provide more accurate results.

### EXAMPLES

The following non-limiting Examples are provided to further illustrate the present disclosure.

### Example 1

In this Example, blood stains from dogs were evaluated for aging using the methods of the present disclosure.

Fresh blood (˜60 minutes of blood draw) from four different dogs was plated onto plastic Petri dishes. The blood was left exposed to room air and ambient light. At certain time points (every 4 hours for the first day, every 8 hours for days 2-5, and once a day thereafter for 90 days), the bloodstain was scraped from the middle of the blood stain on the plate and dissolved in phosphate-buffered saline (PBS) 1× buffer (available from Mediatech, Inc., Manassas, Va.) to eliminate the effect of pH and other environmental factors. The blood samples were briefly vortexed (˜1 min), sonicated (˜1 min), and centrifuged (13 g, 1 min) The resulting clear supernatants served as the working stock solution for fluorescence lifetime measurements. Each measurement was conducted from three different scratches of blood obtained from the four different dogs. A small fraction (˜10-100 μl) of the solution was added into a quartz cuvette and diluted with an appropriate amount of PBS (˜1˜3 ml) such that the fluorescence intensity of the sample was large enough for lifetime measurements, but not so large to avoid “photons pile-up” leading to the distortion of the measurement.

Fluorescence lifetime measurements were measured using the time correlated single-photon-counting technique (TCSPC) in quartz cuvettes with a 295 nm excitation source NanoLED® with an impulse repetition rate of 1 MHz (available from Horiba Yvon Jobin, Edison, N.J.) at 90° to the detector PMT R928P (available from Hamamatsu Photonics, Japan). The slit values were set to 10 nm for all experiments. The detector was set to 350 nm and the data was collected until the peak signal reached 10,000 counts. The lifetime was recorded on a 100 ns scale. The instrument response function was obtained using a Rayleigh scatter of Ludox-40 in water in a quartz cuvette at 320 nm emission. Shorter wavelengths potentially excite tyrosine residues leading to energy transfer to tryptophan, while longer wavelengths excite NAD(P)H and other components of blood. These excitations may contaminate the tryptophan decay kinetics and thus may complicate the lifetime data analysis. By limiting excitation and emission wavelengths as described above, however, fluorescence lifetime values of the tryptophan could be preferentially collected. Further, it should be understood by one skilled in the art, that the fluorescence lifetime of other components of blood could be measured in the same manner as described above, utilizing different excitation and emission waveguides achieved through routine experimentation.

Fluorescence lifetime was calculated from two-or three exponential fit using DAS6 decay analysis (Horiba) and errors did not exceed 4%. The goodness of fit was judged by X² values and Durbin-Watson parameters and visual observations of fitted line, residuals and autocorrelation function. For multiexponential decays, two parameters were collected: individual lifetimes of each component (τᵢ) and their fractional contributions (fᵢ). The collective fluorescence lifetime was then calculated according to the following equation:

υ̅=f₁τ₁+f₂τ₂+ . . .

wherein f₁, f₂—fractional contributions, τᵢ, τ₂—individual lifetimes of each component.

Two phase decay modeling, implemented in data analysis software Prism 5 (available from GraphPad Software Inc., La Jolla, Calif.) was applied to the dataset of all lifetime data obtained from the four different dogs at different time points (every 4 hours for the first day, every 8 hours for days 2-5, and once a day thereafter for 90 days). In this model, the outcome was assumed to be the result of the sum of a fast and slow exponential decay according to the set of following equations:

Y= τ̅₀̅₀̅+SpanFast×e^{-K}^{_{fast}}⁵+SpanSlow×e^{-K}^{_{slow}}⁵,

SpanFast=( τ̅₀̅− τ̅₀̅₀̅)×(Percent Fast)/100

SpanSlow=( τ̅₀̅− τ̅₀̅₀̅)×(100−PercentFast)/100

wherein τ̅₀̅ is the value of the lifetime when time is zero, τ̅₀̅₀̅ the lifetime at infinite time, K_{fast} and K_{slow} are the two rate constants, all expressed in hrs⁻¹, and PercentFast, which is the span (from τ̅₀̅ to τ̅₀̅₀̅) accounted for by the faster of the two components. The result of this model provides two time constants t_{fast} and t_{slow}

t_{fast}=1/K_{fast} and t_{slow}=1/K_{slow}

Half-life (fast) and half-life (slow) are computed as ln(2)/K_{fast} and ln(2)/K_{slow}, correspondingly.

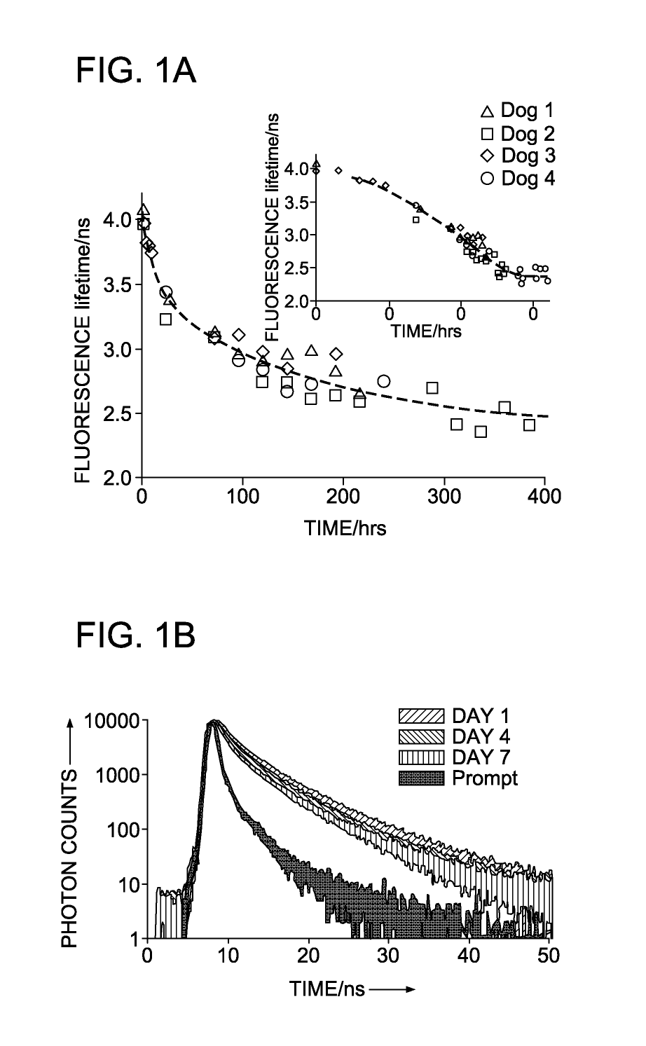

As shown in FIG. 1A, upon aging, the fluorescence lifetime undergoes a non-linear decrease from ˜4.0 ns for “fresh” blood almost immediately after drawing to ˜2.5 ns for a two-month old bloodstain, reaching a plateau after ˜300 hrs. The most drastic change in lifetime occurred in the first 150 hours, or ˜7 days. FIG. 1B shows the change of the fluorescence decay during the first 7 days after the bloodstain plating, resulting in a decreased slope of the curve, and hence the lowering of the fluorescence lifetime. The two phase exponential modeling of the fluorescence lifetime change with time revealed fast and slow components in the degradation process: fast, (half-life ˜9.7 hours, 34%) and slow (half-life ˜116 hours, 66%), R²=0.96. Although the nature of this behavior is unknown, the presence of the two phases was attributed to the rates of enzymatic degradation of the two major blood proteins: albumin and γ-globulins.

### Example 2

In this Example, the fluorescence lifetime of tryptophan from neat albumin and γ-gluobulin samples was measured.

Samples of neat albumin and γ-globulins were prepared and the fluorescence lifetime was measured in the same manner as the blood samples of Example 1. Bovine serum albumin, bovine γ-globulins, and L-tryptophan were purchased from Sigma-Aldrich (St. Louis, Mo.). For lifetime measurements, fresh albumins were dissolved in PBS buffer, and their solutions were adjusted to obtain the desired count rate (alpha value 1-3%) in TCSPC acquisition mode. A lower count rate requires an impractically long acquisition time, while higher count rate results in the data distorted by the pile-up effect. For aging experiments, up to 4 mg of bovine serum proteins, bovine γ-globulins and L-tryptophan were dissolved in 1 mL of PBS buffer until complete dissolution and plated in the same manner as the blood samples of Example 1. Aliquots of the samples were diluted with urea of different concentrations in water.

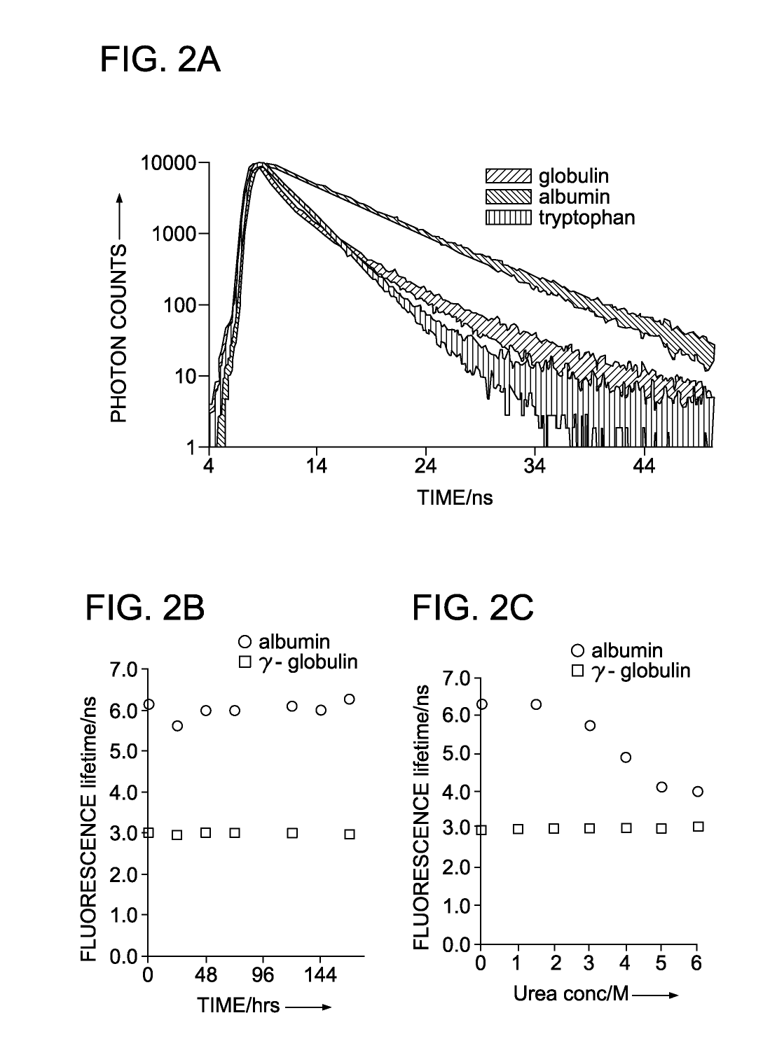

Neat albumin and γ-globulins showed noticeably different fluorescence lifetimes: τ_{alb}˜6.3±0.08 ns and τ_{glob}˜3.0±0.07 ns. The latter was close to the lifetime of free tryptophan with τₜᵣₚ˜2.7±0.15 ns (see the decay of a free tryptophan in FIG. 2A). Such a difference in fluorescence lifetime is the direct evidence of tryptophan sensitivity to the environment. As expected, albumin (with two Trp residues) and neat tryptophan decays are close to monoexponential, while γ-globulin (with up to ten or even more Trp residues) is multiexponential.

Further, these samples did not present with any fluorescent lifetimes alternation over a 7-day period (FIG. 2B). This suggests that factors other than oxygen and moisture from the air are responsible for lifetime changes in blood. However, under unfolding conditions, the lifetime of albumin experienced gradual decrease with the increase of the urea concentration from initial 6.3 ns to 4.0±0.14 ns in 6M urea solution. In contrast, similar conditions did not affect the lifetime of γ-globulins, indicating its conformation stability (FIG. 2C).

In summary, fluorescence lifetime was shown to be a promising technique to evaluate the age of blood within the first week. The method is fast (˜20 min), reproducible, concentration independent, and requires a miniscule amount of the blood with minimal sample preparation.

### Example 3

In this Example, albumin proteins from various mammalian species were measured for their fluorescence lifetime properties.

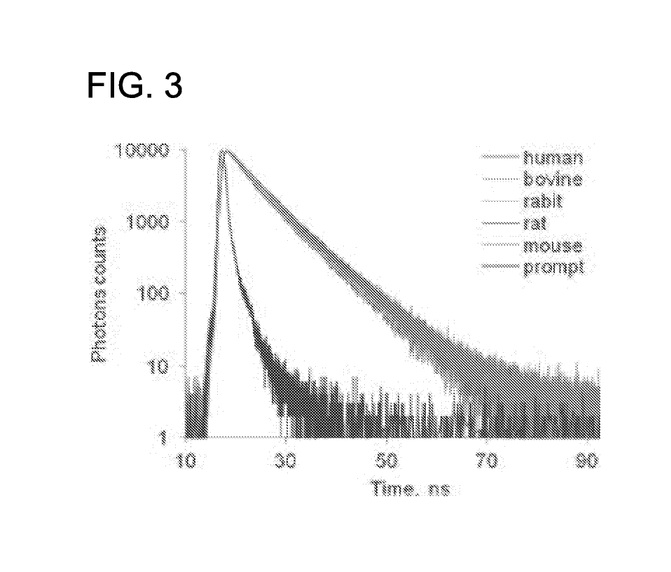

Particularly, albumin from human, bovine, rabbit, rat, and mouse were prepared and the fluorescence lifetime was measured in the same manner as the neat albumin samples of Example 2. The samples were excited at 295 nm and their fluorescence lifetime values were evaluated. The results are shown in FIG. 3.

As shown in FIG. 3, the fluorescence lifetimes properties of the samples were similar as indicated by the shape of the shown decays and corresponding lifetime values, such as individual lifetimes (τ₁, τ₂), their fractional contributions (f₁, f₂), and the average lifetime ( τ̅). In summary, these fluorescence lifetime properties of albumin are highly conserved among different species.

Furthermore, the molecular composition of albumin found in these mammals was also evaluated. The protein chain is composed of almost an equal number of amino acids (607 for humans, 608 for dogs, and 609 for bovines). Sequence comparison searches using BLAST software revealed a high level of homology between these mammals. For example, 79% of amino acid residues in dog albumin and 75% in bovine albumin were found to be identical to human albumin.

### Example 4

In this Example, solid state fluorescence lifetime measurements were evaluated for potential applications in dating blood.

Specifically, NADH and FAD were used for fluorescence lifetime measurements of a three-week old bloodstain. Solid blood stains from dogs were evaluated. Fresh blood (˜0 minutes of blood draw) from a dog was plated onto plastic Petri dishes. The blood was left exposed to room air and ambient light for three weeks. The fluorescence lifetime measurements were measured using ˜405 nm excitation from a pulsed laser and emission collected on a 435 nm filter on a Becker-Hickl imagining microscope (available from Becker & Hickl GmbH, Berlin, Germany).

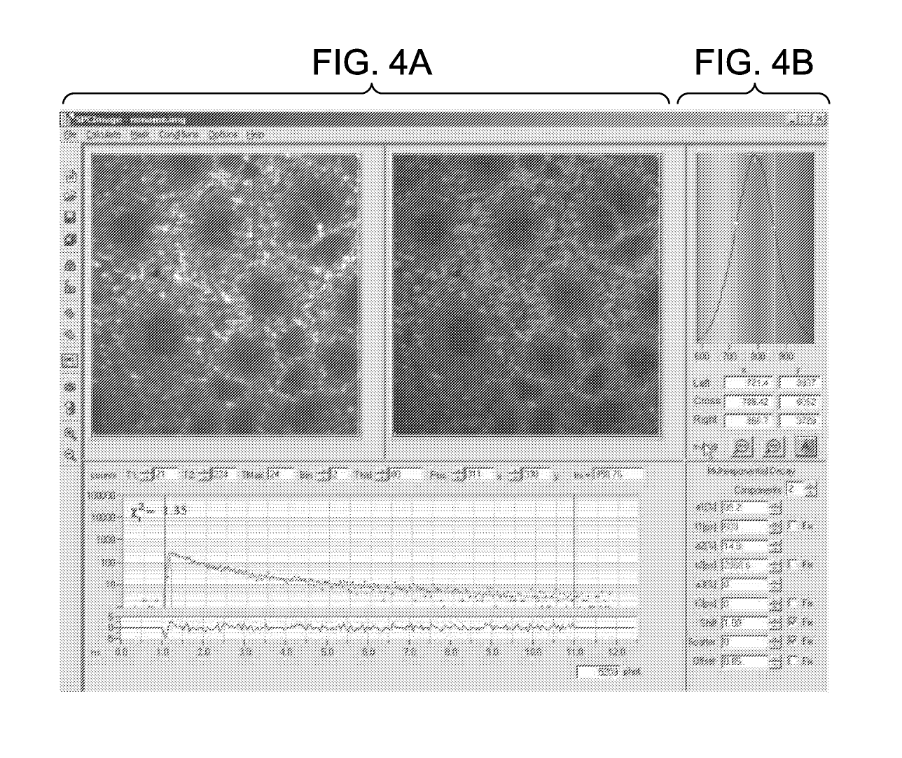

The results shown in FIG. 4 demonstrate that a fluorescence lifetime map can be generated from solid state blood using an imaging device suitable for lifetime measurements, such as a fluorescence lifetime microscope. In the presented color panel, the distribution of fluorescent lifetimes from endogenous fluorophores such as NADH and FAD is shown. Each pixel on the image represents fluorescence decay, from which a fluorescence lifetime value can be calculated.

These results are surprising and unexpected as solid materials rarely fluoresce, showing the improved capabilities of the methods of the present disclosure.

This written description uses examples to disclose the invention, including the best mode, and also to enable any person skilled in the art to practice the invention, including making and using any systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for determining the age of a biological sample, the method comprising measuring a fluorescence lifetime value of the biological sample.

2. The method of claim 1 wherein the measuring of the fluorescence lifetime value comprises detecting a conformational change of at least one endogenous fluorophore in the biological sample.

3. The method of claim 2 wherein the endogenous fluorophore is selected from the group consisting of fluorescent amino acids, porphyrins, lipofuscin, nicotinamide adenine dinucleotide phosphate-oxidase, FAD-binding proteins, and chlorophylls.

4. The method of claim 1 wherein the measuring of the fluorescence lifetime value comprises detecting a conformational change of at least one protein in the biological sample.

5. The method of claim 4 wherein the protein is selected from the group consisting of albumin, globulin, fibrinogen, hemoglobin, bilirubin, melanin, lignin, elastin, collagen, and combinations thereof.

6. The method of claim 1 wherein the fluorescence lifetime value comprises the fluorescence lifetime of a tryptophan residue of the protein in the biological sample.

7. The method of claim 1 wherein the biological sample is a biological fluid.

8. The method of claim 7 wherein the biological fluid is selected from the group consisting of blood, breast milk, bile, cerebrospinal fluid, gastric juice, mucus, saliva, semen, sweat, tear, urine, and combination thereof.

9. The method of claim 1 wherein the measuring of the fluorescence lifetime value comprises mixing the biological sample with a buffer.

10. The method of claim 1 comprising measuring the fluorescence lifetime value of the biological sample when the biological sample is in a solid state.

11. The method of claim 1 wherein the biological sample is a dried biological sample selected from the group consisting of blood, breast milk, bile, cerebrospinal fluid, gastric juice, mucus, saliva, semen, sweat, tear, urine, and combination thereof.

12. The method of claim 1 further comprising:
measuring a fluorescence lifetime value of a standard biological sample at at least one pre-determined age; and
comparing the fluorescence lifetime value of the biological sample to the fluorescence lifetime value of the standard biological sample.

13. The method of claim 12 wherein the standard biological sample is a second biological fluid.

14. The method of claim 13 wherein the second biological fluid is selected from the group consisting of blood, breast milk, bile, cerebrospinal fluid, gastric juice, mucus, saliva, semen, sweat, tear, urine, and combination thereof.

15. The method of claim 1 wherein the biological sample is an extract of a biological fluid selected from the group consisting of blood, breast milk, bile, cerebrospinal fluid, gastric juice, mucus, saliva, semen, sweat, tear, urine, and combination thereof.

16. The method of claim 1 wherein the measuring of the fluorescence lifetime value comprises determining the presence of at least one of an organic quencher and an inorganic quencher.

17. The method of claim 16 wherein the quencher is selected from the group consisting of a primary amine, secondary amine, tertiary amine, water and an unbound iron-ion.

18. A method for determining the age of a blood sample, the method comprising measuring a fluorescence lifetime value of the blood sample.

19. The method of claim 18 wherein the measuring of the fluorescence lifetime value comprises detecting a conformational change of at least one protein in the flood.

20. The method of claim 19 wherein the protein is selected from the group consisting of albumin, globulin, and combinations thereof.
